(19) United States
(12) Patent Application Publication
(10) Pub. No.: US 2006/0080217 A1
(43) Pub. Date: Apr. 13, 2006

(54) Clearing house for buying and selling short term liquidity

(76) Inventors: Grenville W. Blackall, Stillwater, MN (US); Lynn R. Evans, Portland, OR (US)

Correspondence Address: GRAY, PLANT, MOOTY, MOOTY & BENNETT, P.A., P.O. BOX 2906, MINNEAPOLIS, MN, 55402-0906, US

(21) Appl. No.: 11/153,797

(22) Filed: Jun. 15, 2005

Related U.S. Application Data
(60) Provisional application No. 60/606,391, filed on Aug. 31, 2004.

(51) Int. Cl. G06Q 40/00

(52) U.S. Cl. 705/37

(57) ABSTRACT

A clearing house process for buying and selling short term liquidity, such as Fed Funds, by financial institutions into an open, fair, and efficient market. The process automatically matches all trades at a preset rate and automatically clears and confirms the trade through a secure on line website. Sellers manage their buying partner risk up front by selecting individual partners, regional partners, and/or partners with predetermined risk profiles, as well as by limiting dollar exposure to each partner as a percent of equity. Rates are published on the system each day. The trading financial institution enters its trades by an individual approved by the financial institution. The clearing house process may also comprise a few selected high quality upstream correspondent banks for excess liquidity and a settlement arrangement through the Federal Reserve Bank.

### CROSS-REFERENCE TO RELATED APPLICATION

This application claims the benefit of U.S. Provisional Application No. 60/606,391, filed Aug. 31, 2004, entitled “Method of Bank Liquidity Optimization” which is incorporated herein by reference in its entirety.

### FIELD OF THE CLEARING HOUSE PROCESS

This technology relates to a trade-to-settlement clearing house for buying and selling short term liquidity such as Federal Funds among financial institutions.

### BACKGROUND

The clearing house process described in this specification is a financial process for buying and selling, at a market rate, short term liquidity such as Federal Funds in an open, fair market. It is not a process in which buyers and sellers seek a specific buyer or seller. Rather, the clearing house process functions to automatically match buyers and sellers according to predetermined criteria. The clearing house process is variously referred to in this specification as “liquidity clearing house,” “liquidity clearing house process,” “process,” “liquidity clearing house system,” “system,” or “clearing house.”

Banks trade Federal Funds among themselves at amounts that can exceed 400 billion per day. These exchanges originally surfaced as a method by which banks managed their reserve requirements by increasing or decreasing their balances at the Federal Reserve Bank. The Federal Reserve has positioned themselves as a seller (lender) of Federal Funds to banks at the Federal Reserve Discount Rate to allow banks in need of funds to always have a place to obtain sufficient reserves against deposits. The Federal Funds market has evolved to also be a place where banks go to manage their end of day positions, and thus their short term liquidity. Trades of Federal Funds between banks, (predominantly without the Federal Reserve involved), constitute a method for banks to either borrow or invest short term cash.

Short term liquidity among financial institutions, especially in the market of unsecured Federal Funds, is not now an open, national exchange. It is a market run by various large financial institutions, often referred to as upstream correspondent banks or upstreams. The Federal Reserve also provides a source of Federal Funds, but they constitute only a small percent of the total selling in the market. Upstream correspondent banks trade short term liquidity with their smaller customer financial correspondents, often referred to as downstream correspondent banks or downstreams.

The liquidity clearing house is a vehicle for financial institutions to settle short term liquidity needs, whether they be Fed Funds or other types of liquid funds. An implementation of the liquidity clearing house is a web based computerized trading process. It solves the problem that has burdened liquidity management of banks—the surprising lack of an efficient market for trading liquidity. The Federal Funds market in particular has historically lacked an efficient way to buy and sell funds. There is no “market price” —bid/ask spreads on Federal Funds. And volatile availability also limits liquidity and forces buyers to spend a considerable amount of time finding upstreams willing to extend them credit.

Downstream correspondent banks have had to rely on an inconsistent source of funds offered by upstream correspondent banks who manage their downstream activity based on their own daily needs. Downstream correspondent banks who wish to get the best borrowing rate need to maintain many upstream correspondent bank relationships and must spend time and energy querying them to find the best rate.

Although relaxation by the Federal Reserve of some borrowing restrictions has opened up more liquidity, it still does not change the fact that the short term liquidity (especially Federal Funds) market between financial institutions is (a) primarily under the control of various upstream correspondent banks and (b) not a true clearing house like those that can be found in other financial markets (e.g. Treasuries, Mortgage Backed Securities, and Equities).

Upstream correspondent banks face a conundrum in the market of Federal Funds and the provision of liquidity for downstream correspondent banks as well. Just because they dominate the market today does not mean they would not benefit from a clearing house process. The upstream correspondent bank business is an important line of business for them, one that returns significant opportunity for access to a broad base of fee generating business. For those who truly wish to accommodate their downstream correspondent bank's needs, they have to consider providing liquidity. The obstacle is that for those downstream correspondent banks who need funding (are wishing to buy Federal Funds or other short term liquidity), the upstream correspondent bank's loan to the downstream must be carried on its balance sheet. When downstream correspondent banks have excess funds to sell, the upstream correspondent bank can easily pass this on to other upstream correspondent banks as an agent. But when downstream correspondent banks want to buy, the upstream correspondent bank must sell them the money themselves as a principal. This creates balance sheet pressure on the upstream correspondent bank, as it ends up with assets (Fed Funds sold) and liabilities (Fed Funds purchased) on their balance sheet at the same time, with a very thin margin.

This balance sheet phenomenon is yet another reason the Federal Funds market lacks liquidity, as many upstream correspondent banks withhold liquidity to downstream correspondent banks to prevent negative balance sheet impacts.

It is worth noting that, although downstream correspondent banks typically use upstream correspondent banks for their Federal Funds needs, if a clearing house process existed to match buyers and sellers, the smaller banks could have almost funded themselves. The average Federal Funds sold for year end balances from 1992 to 2003 for all banks under 3 billion in assets, was 47.8 billion, while the Federal Funds purchased for this same period was 41.9 billion (FDIC web site: fdic.gov, the SDI database.). This means that 88% of the buy and sell needs could have been met within the community of banks under 3 billion, which is 97.2% of all banks. In reality, most of this Federal Funds demand was satisfied by the few upstream correspondent banks over 3 billion—a sure sign that a clearing house market does not exist today for liquid funds, such as Fed Funds.

The liquidity clearing house process harnesses the available sources of liquidity among the smaller banks and benefits the upstream banks by allowing them to move away from managing downstream correspondent liquidity as a loss leader and a balance sheet margin drag.

The liquidity process is a comprehensive yet simple to use bank credit risk management system that provides participants a way to choose and monitor the banks to whom they sell within Regulation F guidelines. On a daily basis, participants buy or sell at a common rate they know up front. Trades are made automatically through a process that assigns sellers to buyers based on sellers' approved choices. The process also includes automated daily settlement, electronic confirmation, an easy to use website for controlling parameters, and a wealth of risk management and audit trail reports. The process can manage unsecured Federal Funds as well as short term buying and selling of secured transactions with repurchase agreements.

Trades may be cleared through an upstream account or directly through the Federal Reserve.

The liquidity clearing house process benefits buyers and sellers of funds with better rates, more liquidity, and automated operations. It also benefits partnering upstreams by providing them an avenue to move away from managing downstream correspondent liquidity as a loss leader and a balance sheet margin drag. The clearing house allows the partnering upstreams to maintain their correspondent relationships, but move unneeded liquidity trading off their balance sheet. The process also gives both partnering upstreams and downstreams the opportunity to seek out new correspondent relationships across broad geographic areas; automates Fed Funds operations; and manages risk.

Moreover, comprehensive audit reports and approval documents generated by the liquidity clearing house process provide clear assurance of Regulation F Compliance.

### SUMMARY

The clearing house is a process for buying and selling short term liquidity, such as Fed Funds, by financial institutions into an open, fair, and efficient market. The process automatically matches all trades at a preset rate and automatically clears and confirms the trade through a secure on-line website. Sellers manage their buying partner risk up front by selecting individual partners, regional partners, and/or partners with predetermined risk profiles, as well as by limiting dollar exposure to each buyer to a percent of the buyer's equity. Rates are published on the system each day. The trading financial institution enters its trades by an individual approved by the financial institution. The clearing house process may also comprise a few selected high quality upstream correspondent banks to provide excess liquidity and a settlement arrangement through the Federal Reserve Bank.

The liquidity clearing house is a computer process for automating management of subscriber short term liquidity. The process calculates a risk parameter for seller subscribers based upon the buyer subscriber's published financial information and its short term liquidity borrowing activity. The process includes the specification of the buyers to which a seller will sell short term liquidity and the maximum amount the seller will sell to each specified buyer. It discloses the rates for buying and selling short term liquidity in advance of trading the short term liquidity.

The clearing house process enables directed short term liquidity trading in either a target amount over a specific period of time or a specific amount at a specific time. The target amount is the amount the subscriber designates to be maintained in its account. The amount of the target directed trade to maintain the target amount comprises the difference between (a) the amount the subscriber designates to be maintained in its account and (b) the amount that is the actual balance in the subscriber's account at the time of the trade. The target directed trade is a directed sale of funds if the difference is positive and a directed buy of funds if the difference is negative. The subscriber's account is maintained with an upstream correspondent bank. Upon subscriber's entry of a target directed trade, the subscriber specifies the target amount and specifies the period of time during which the process is to implement the target trade. The specific period of time is a specific period of days.

The process also enables optional short term trading to satisfy unmet directed short term trading. It implements short term buyer and seller trades by matching a buyer's order with a seller's order that meets the seller's risk parameter and has the same clearing house as the seller. The process first satisfies directed trades and then satisfies unmet directed trades with optional trades. The clearing house process executes final settlement of trades through the buyer's and sellers' respective settlement accounts and sends confirmation of trades to the seller and buyer.

The computer process calculates the risk parameter based upon parameters comprising: (a) Tier 1 capital; (b) ratio of equity to total assets; (c) ratio of nonperforming loans to total assets; (d) percentage change in ratio of nonperforming loans to total assets; (e) ratio of nonperforming loans to total equity; (f) percentage change in ratio of equity to total assets; (g) loan to deposit ratio; (h) net interest margin, comprised of the ratio of net interest income over earning assets; (i) absolute change in net interest margin; and (j) other factors chosen by the clearing house from time to time. The parameters upon which risk is calculated also comprise buyer credit worthiness based upon buyer's adequacy of capital, asset quality, earnings coverage, and liquidity. The computer process periodically determines an LCH Score by translating the combined risk parameters into a number between zero and one-hundred. Determination of the buyers to which a seller will sell short term liquidity is also based upon a buyer's LCH Credit Score, its Federal Reserve Call Report Data, and its geographic region of the country. The seller may also exclude or include specifically named buyers to which it will sell.

The computer process can, for example, also manage the seller's credit risk as follows: (a) if a buyer buys short term liquidity more than X days in a rolling Z day period and less than Y days in a rolling Z day period, the buyer pays the seller an extended interest rate spread, where X, Y, and Z are predetermined by the process and (b) if a buyer buys short term liquidity more than Y days in a rolling Z day period, the buyer may not buy short term liquidity at all and must use secured buying of short term liquidity, where Y and Z are predetermined by the process.

The disclosed buying and selling rates are guaranteed.

The computer process uses a four iteration algorithm for matching buyers with sellers. The first iteration matches seller directed trades with buyer directed trades if the buyer meets seller's risk parameters and buyer and seller subscribers share a common clearing bank that is not the Federal Reserve Bank. The second iteration matches remaining unmatched seller directed trades with buyer directed trades if the buyer meets seller's risk parameters and buyer and seller share a common clearing bank, including the Federal Reserve Bank. The third iteration matches any remaining unmatched seller subscriber directed trades with buyer subscriber optional trades if the buyer meets seller subscriber's risk parameters and buyer and seller share a common clearing bank that is not the Federal Reserve Bank. The third iteration matches any remaining seller optional trades with buyer directed trades if the buyer meets seller's risk parameters and buyer and seller subscribers share a common clearing bank that is not the Federal Reserve Bank. The fourth iteration matches seller (i) directed trades with buyer optional trades if buyer meets seller's risk parameters and buyer and seller subscribers share a common clearing bank, including the Federal Reserve Bank and (ii) optional trades with buyer directed trades if buyer meets seller risk parameters and buyer and seller subscribers share a common clearing bank, including the Federal Reserve Bank.

### BRIEF DESCRIPTION OF THE DRAWINGS

FIG. 1 depicts an embodiment of iterative steps of matching buyers and sellers.

FIG. 2 depicts an embodiment of steps to construct and maintain a Sell-To list.

FIG. 3 depicts an embodiment of process's credit risk mitigators.

FIG. 4 depicts an embodiment of an unsecured rate and spread structure.

FIG. 5 depicts an embodiment of an LCH Credit Score.

FIG. 6 depicts an embodiment of a secured program.

FIG. 7 depicts an embodiment of a Regulation F analysis report.

FIGS. 8A and B depict an embodiment of an LCH Bank Score report.

FIG. 9 depicts an embodiment of a daily Federal Funds confirmation report.

FIG. 10 depicts an embodiment of a daily confirmation report.

FIG. 11 depicts an embodiment of an exposure report.

FIGS. 12A and B depict an embodiment of monthly summary reports.

### DESCRIPTION OF EMBODIMENTS

The clearing house is a process for buying and selling short term liquidity, such as Fed Funds, by financial institutions in an open, fair, and efficient market. The process automatically matches all trades at a preset rate, clears the trades, and confirms the trades through a secure on-line website. Sellers manage their buying partner risk by inputting and updating a Sell-To list into the system. The Sell-To list is the financial institution's selection of individual partners, regional partners, and/or partners with predetermined risk profiles. The seller may also enter a dollar exposure limit into the system for sales to each partner as a percent of the buying partner's equity. The buy—sell interest trade rates are published on the system each day. The trading financial institution enters its trades by an individual approved by the financial institution. The clearing house process may also comprise a few selected high quality upstream correspondent banks for excess liquidity and a settlement arrangement through the Federal Reserve Bank.

The clearing house process is a web based process for a trade-to-settlement market clearing house for buying and selling Federal Funds and other short term liquidity among financial institutions. It is important to clarify that this is not a process whereby a buyer of Federal Funds seeks and approves a particular seller of Federal Funds (or visa versa). This is not a brokerage process which simply offers a way for buyers and sellers to find possible partners for a trade and then decides whether to carry it out. This is a clearing house in which participants do not know which of their approved financial institutions take the other side of their transaction until after the trade is complete. One embodiment of the clearing house process serves the needs of commercial banks, thrifts, and savings banks.

The clearing house receives instructions for trading short term liquidity instruments between financial institutions (entering the trades manually or automatically relative to a target balance) and then automatically executes and settles the trades under pre-defined risk management parameters compliant with Regulation F. It improves the downstream correspondent bank's (often referred to as community bank's) access, liquidity, and efficiency by providing a clearinghouse for buying and selling Federal Funds between them, with an upstream correspondent bank acting as an agent.

All financial institutions wishing to participate in the clearing house process must (a) first be approved for membership by the clearing house process and (b) have an account at a Federal Reserve Bank or have a relationship with an upstream correspondent bank that has an account at a Federal Reserve Bank on behalf of the participating financial institution.

The two types of instruments to be traded within this clearing house are 1) Federal Funds, an unsecured instrument involving the Purchase and Sale of funds between depository institutions. 2) Repurchase Agreements (and Reverse Repurchase Agreements), the buying and selling of Bank portfolio investments (i.e. those which meet regulatory guidelines for depository institutions) under an agreement to reverse the transaction at a preset, usually short term, time in the future.

Fed Funds unsecured selling introduces risk to the seller (the buyer can fail to repay the seller) and, therefore, the seller's loan to the buyer must to be within the seller's risk tolerance. The clearing house process includes a credit management component to reduce the seller's risk. The credit management aspect of the process allows sellers to pre-approve buyers with whom they will trade based upon (a) a credit analysis of the potential buyers, (b) inclusion and exclusion on a regional basis of potential buyers, and (c) any other factor the seller wants. The credit management component coupled with a number of other credit risk components allows sellers to participate in the clearing house with a high level of confidence in the other trading partner participants. It also assures sellers that the clearing house process includes the tools to be fully compliant with Federal Reserve “Regulation F” (Federal Reserve regulation 12 CFR Part 206, available at www.occ.gov), which requires that depository financial institutions limit their exposure to other depository financial institutions.

The clearing house also reduces risk by implementation of a secured short term liquidity program for higher risk buyers to trade Federal Funds. The unsecured program is not available to buyers that the process classifies out of the unsecured program. For example, buyers will be classified as unqualified for participation in the unsecured program if the: (a) buyer's LCH Credit Score is below a level required for the secured program; (b) buyer's historical buying behavior is within a range below that required for the secured program; or (c) liquidity clearing house, for any reason whatsoever, classifies the buyer only for participation in the secured program.

The clearing house includes an automated net settlement process for buy-sell partners who share the same clearing agent. The clearing agents are normally upstream correspondent banks. However, the Federal Reserve is also on every bank's clearing list, so it may be used as a clearing agent of last resort. Clearing is directed by instructions sent to the clearing bank by the process via a file transmission designed to the specifications of the clearing agent. The transmissions go out automatically on a daily basis.

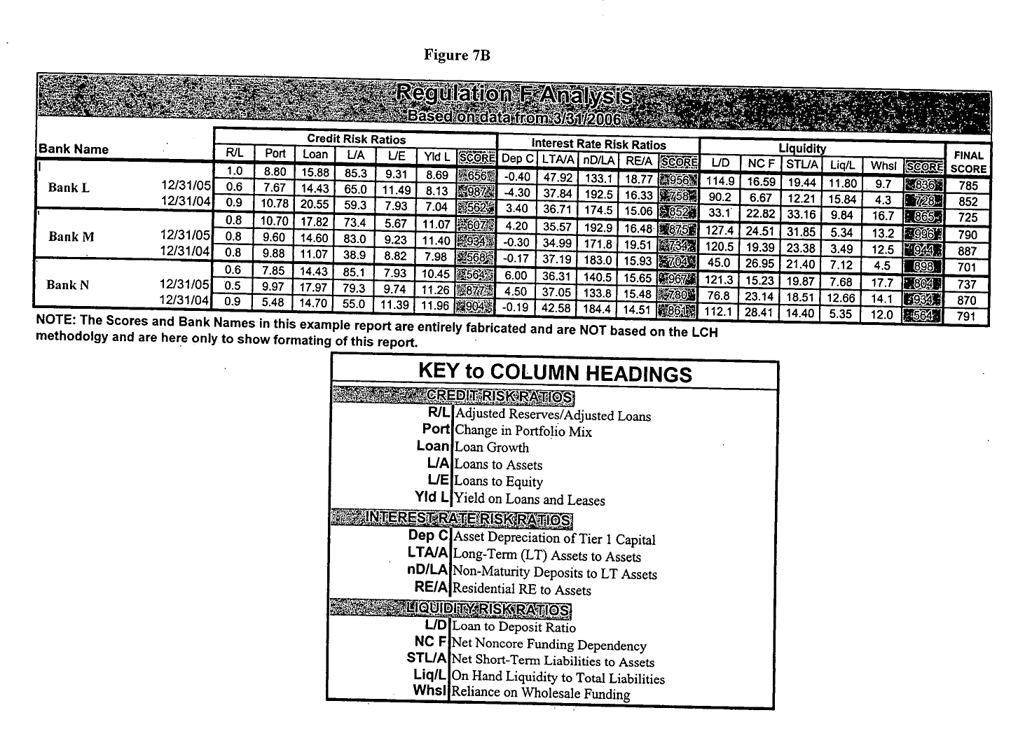

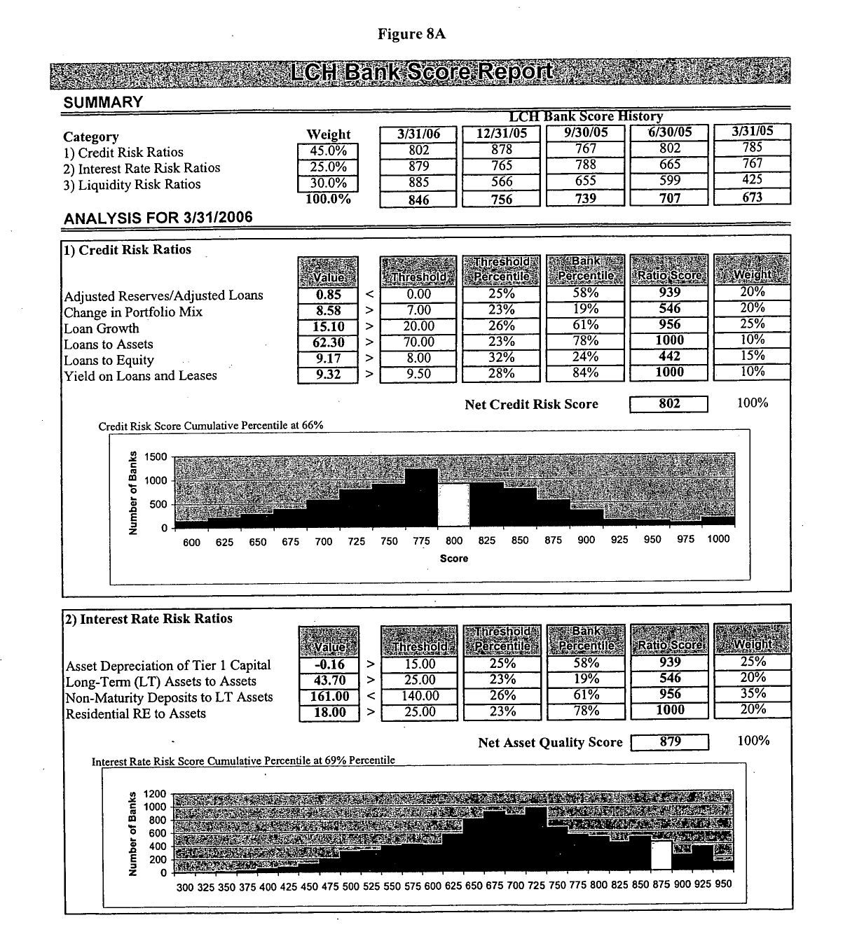

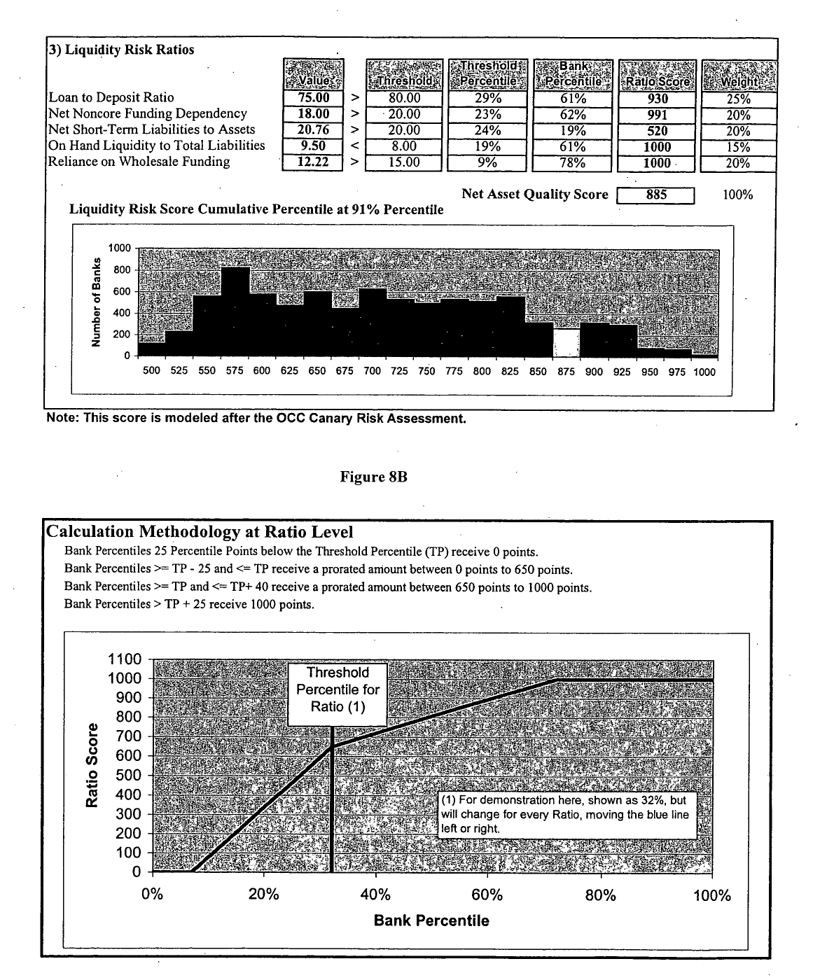

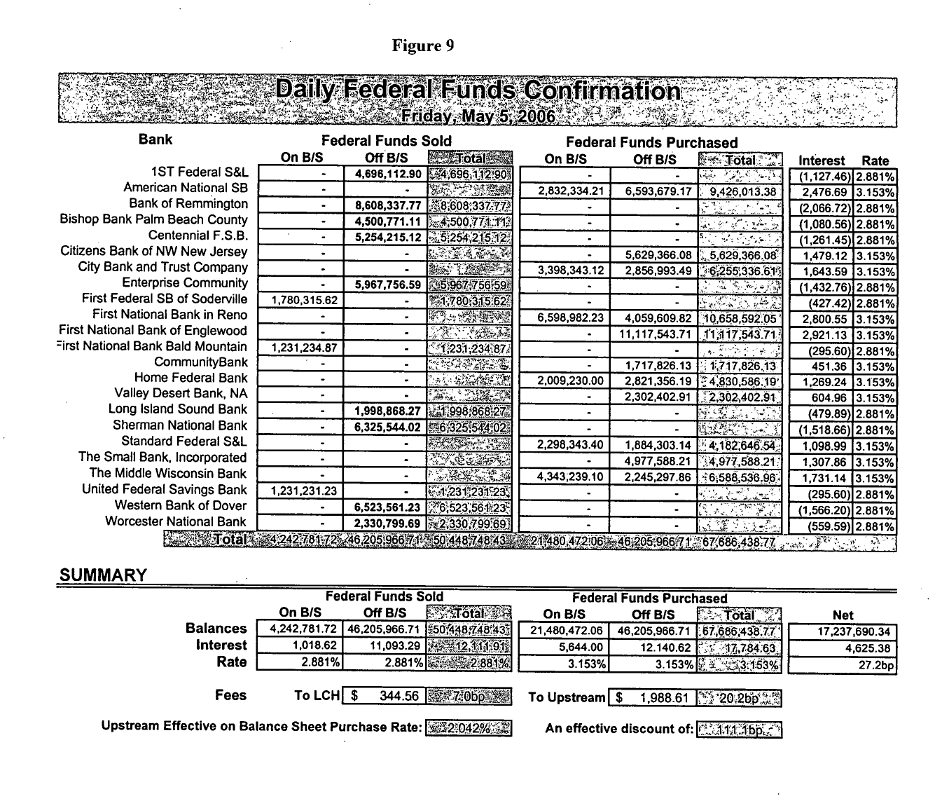

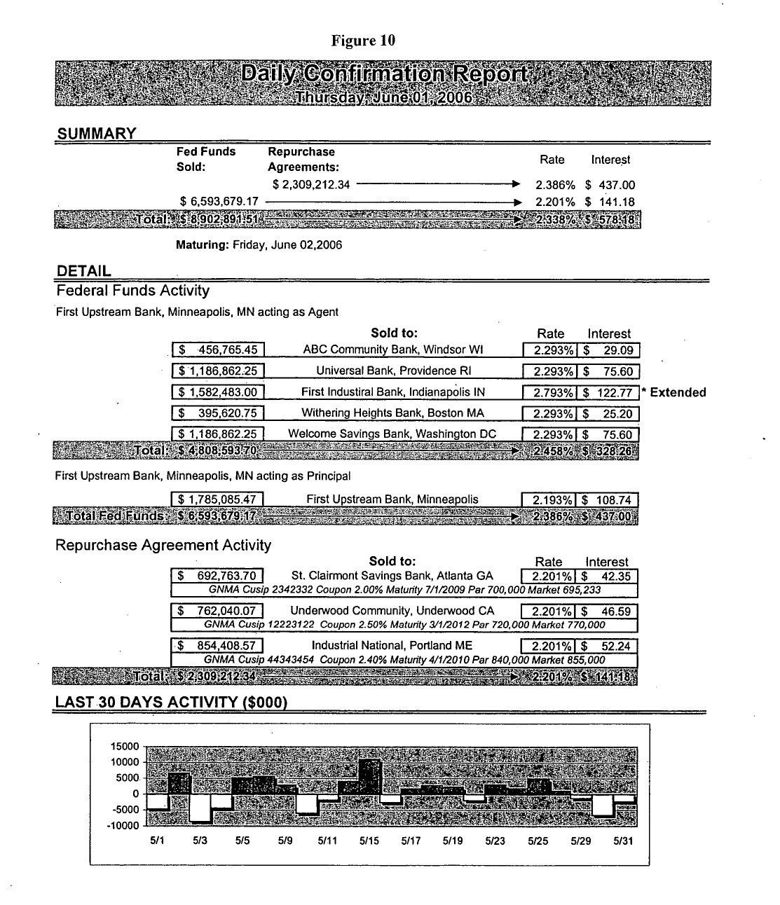

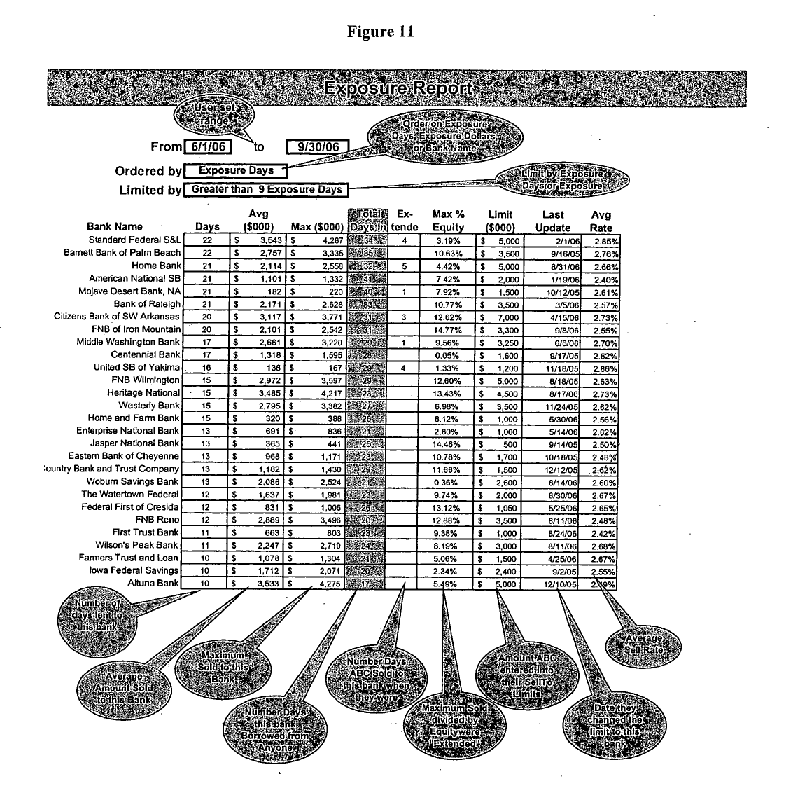

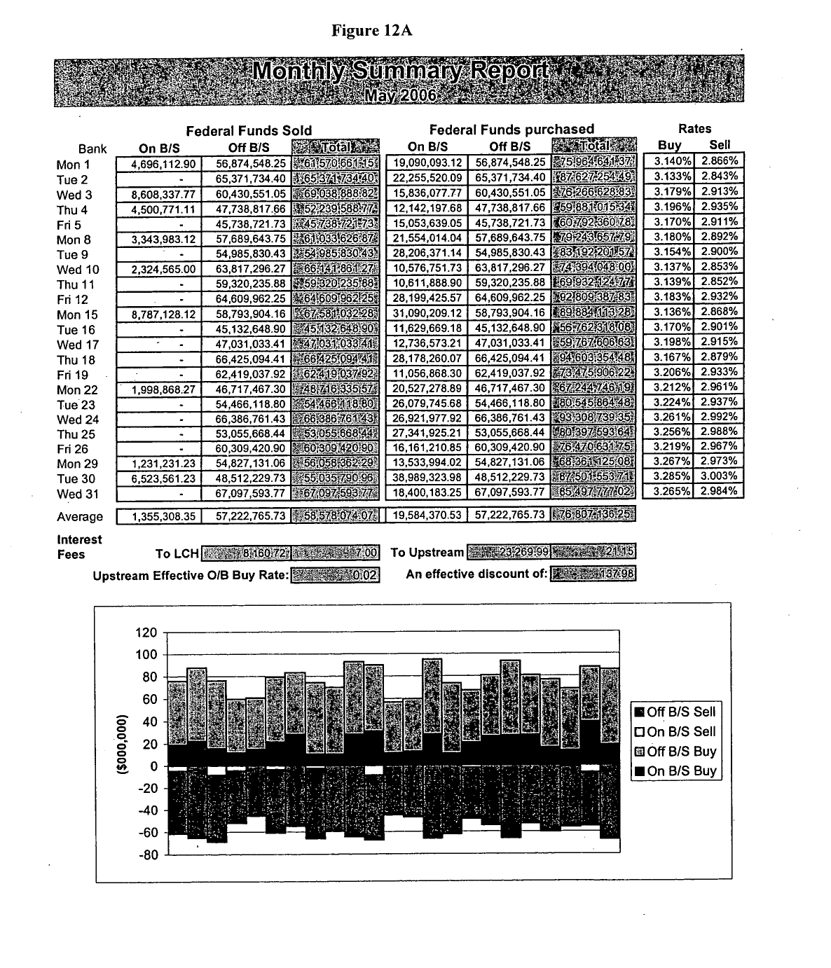

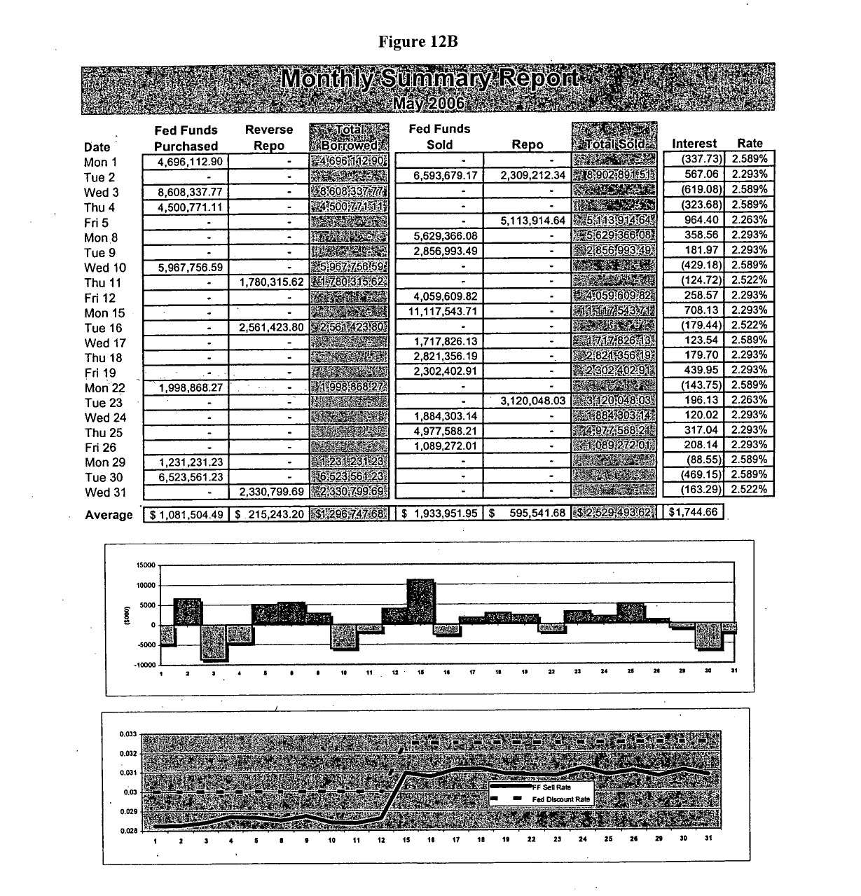

The clearing house includes a secure messaging system for communication with participants. For example, the secured messaging system may be used to deliver periodic reports to clearing house participants, such as audit reports and the reports illustrated in FIGS. 7-12. FIG. 7 is a Regulation F analysis. An LCH Bank Score report is shown in FIGS. 8A and B. FIG. 9 is a daily Federal Funds confirmation report. FIG. 10 is a daily confirmation report of trading activity. FIG. 11 is an exposure report. FIGS. 12A and B are monthly summary reports.

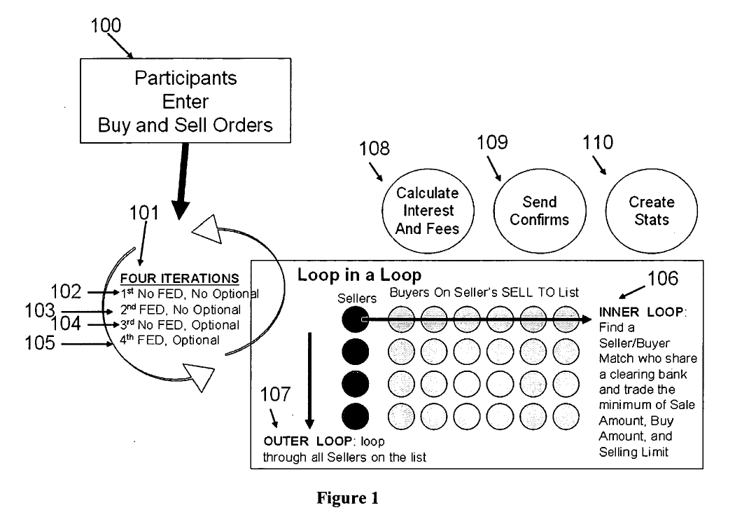

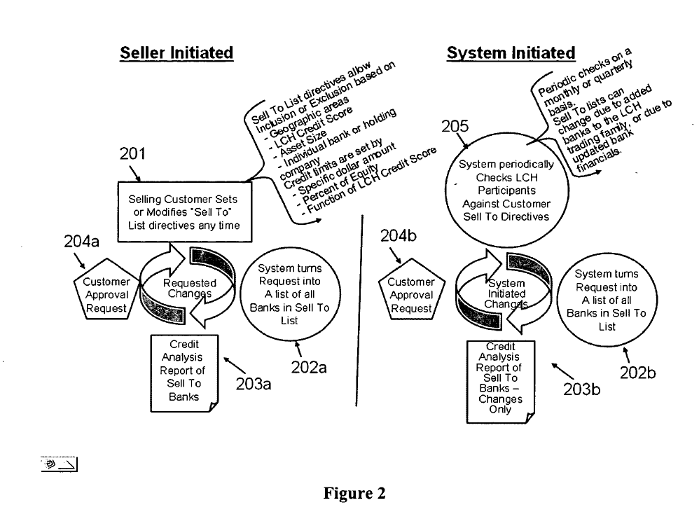

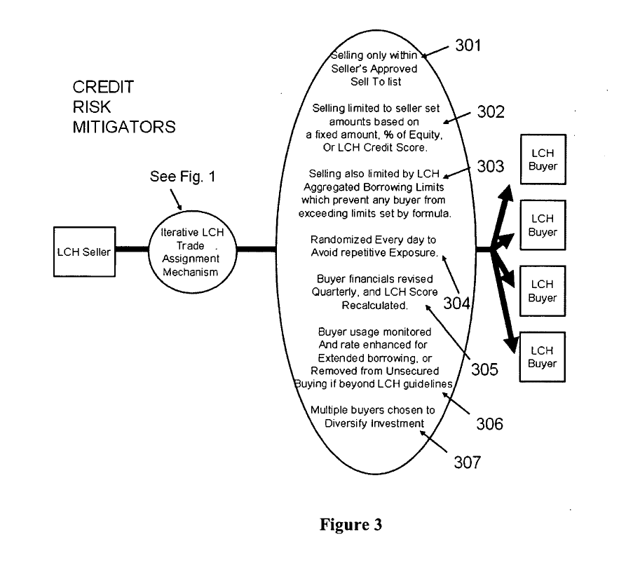

FIG. 1 depicts the sequence of clearing house steps. The sequence begins with entry of a trade at 100 and ends with sending trade confirmations 109 to the seller and buyer. The steps between the beginning and end of the process comprise matching buyers and sellers. Along the way the process captures data, such as the trading interest rate, number of trades, times of trades, and myriad statistical information. Information such as interest rates are made available to all participants for on-line viewing and downloading. Other information such as statistical information relating to the operation of the process is available to the system only.

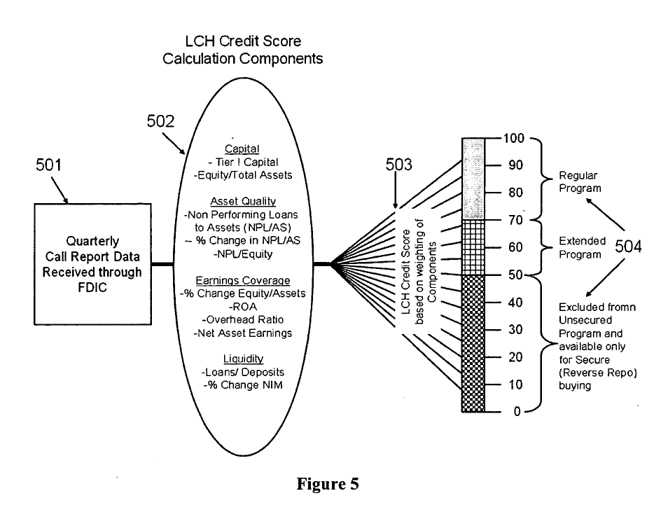

Only financial institutions accepted by the liquidity clearing house may access and use the liquidity clearing house. Each financial institution that becomes a participant in the process must enter into various agreements required by the clearing house. As previously discussed, the process also screens buyers to ensure that the buyer's (a) LCH Credit Score, depicted in FIG. 5, is at a level sufficient to qualify the buyer to buy and (b) buying behavior is within guidelines predetermined by the process, depicted in FIG. 3 at 305.

The process has four classes of trades. They are (i) a directed buy; (ii) a directed sell; (iii) an optional buy; and (iv) an optional sell. A directed buy or sell is a commitment of a specified amount of a trade. Alternatively, a directed buy or sell trade may be a target directed trade. A target directed trade is a commitment of a target trade amount, rather than a specified amount. Trades take place at a directed buy or sell rate (adjusted for any extended spread). An optional buy or sell is a buy or sell order of a participant, usually an upstream correspondent bank, that is willing to buy or sell Fed Funds when there is demand that exceeds the capacity of the directed buyers or sellers in the system. The clearing house uses optional buying and selling trades to satisfy net excesses from directed buying and selling and thereby maintain liquidity in the system. The upstream correspondent bank purchases the net excess of directed buying or selling through optional buying and selling trades and obtains an interest rate enhancement over the directed buy or sell rate. The rate enhancement is built into the optional buy and sell rates (adjusted for any extended spread).

The amount of the target directed buy or sell trade is the difference between (a) the amount the subscriber designates to be maintained in its account over a specific period of time and (b) the amount of the actual balance in the subscriber's account at the time of the trade. The target directed trade is a directed sale of funds if the difference is positive and a directed buy of funds if the difference is negative. The subscriber's account is maintained with an upstream correspondent bank. The specific period of time may be a specific period of days.

A target directed buy or sell trade specifies a target balance, which is the amount the bank wants in its upstream account at the end of every day. The computer process creates a target directed buy or sell amount to reach that target. An example is:
A bank enters a target balance of $4,000,000. Each day, at the end of the day, the liquidity clearing house reads the bank's current balance in its upstream account. If the account balance is $3,550,000, the liquidity clearing house enters a target directed buy of $450,000. Alternatively, if the account balance is $5,120,000, the liquidity clearing house enters a target directed sell of $1,120,000. Each day the target directed buy or sell amount will differ, while the target balance stays constant.

The class of trades and their associated trading amounts are entered into the liquidity clearing house process. An upstream correspondent bank may act as (a) a clearing bank, (b) a provider of optional buying and selling, or (c) both. The upstream may also trade short term liquid funds, such as Fed Funds, as an agent or as a principal. When an upstream correspondent bank trades as a principal it is trading with a downstream correspondent bank and the trade amount appears on the upstream correspondent bank's balance sheet. When an upstream correspondent bank acts as an agent it is clearing trades occurring between two downstream correspondent banks and the trade amount does not appear on the upstream's balance sheet. A downstream correspondent bank is a financial institution acting in the capacity of a buyer and/or a seller of short term liquidity for its own account. They do not clear trades for downstream correspondent banks. In contrast, a clearing financial institution holds accounts for downstream correspondents banks and allows the liquidity clearing house to use the clearing financial institution's systems to pass funds from buyers to sellers. Most clearing financial institutions are also upstream correspondent banks, with the exception of the Federal Reserve Banks which may serve as a clearing agent for the liquidity clearing house, but will not hold, through the liquidity clearing house, any on balance sheet finds.

All interest rates for trades are published and available to all participants in the system on its secure web site. All participants must formally approve its trades each day. A log of the approval is retained by the liquidity clearing house. Only those individuals authorized by the participant can approve the participant's buy and sell orders. The process determines whether a person logging onto the system is an authorized user of the liquidity clearing house process. Authentication is provided through a secure logon system.

As each trade is entered into the system it begins the process of matching sellers with qualified buyers. Before the matching process can begin, the names of sellers and their respective Sell-To lists are inputted into the system. The Sell-To list is a list of financial institutions (within the liquidity clearing house participating institutions) to which a seller will sell funds. The Sell-To list is depicted in FIG. 2. The list is created based entirely on the seller's risk management parameters. It is comprised of inclusions and exclusions of buyers based on the buyer's geographic region, the buyer's LCH Credit Score, the size of the buyer, a specific limit on the amount the selling bank will sell to the buyer (this amount may be set explicitly or as a percent of the buyer's equity), and other factors the seller deems important. The process is designed to automatically keep sellers in compliance with Federal Reserve Regulation F. The Sell-To list is specifically approved by the selling bank.

Randomization of the Sell-To lists in the system is another step used to reduce seller risk. After entry of the Sell-To lists in the system, the process shuffles the lists into a random order and continues to do so on a daily basis. Consequently, the order in which buyers and sellers are matched (sometimes referred to as assigned) to one another is also randomized. And, long term exposure to any one institution is thereby diminished.

The process attempts to match sellers with buyers by cycling through a nested loop depicted in FIG. 1—an outer loop 107 and an inner loop 106. The inner loop 106 seeks to match a seller with a buyer on the seller's Sell-To list. The process does this by sequentially looking through the look-up table of buyers on a seller's Sell-To list to determine whether the buyer wishing to trade is acceptable to the seller. If the buyer is on the seller's Sell-To list, the inner loop 106 determines whether the buyer and seller have a common clearing bank. If they do, the process initiates a trade between the buyer and seller. The trade is limited to the lesser of the seller's selling limit for the buyer, as specified by the seller in its Sell-To list; the minimum amount the buyer has requested; and the liquidity clearing house's aggregated borrowing limit for the buyer. If a trade is not initiated with the first seller queried, the process sequentially loops through the outer loop 107 to determine whether a subsequent seller in the outer loop 107 is a match. The outer loop consists of all seller participants in the liquidity clearing house. For each seller the process loops through the buyers on that seller's Sell-To list in the same manner previously described in this paragraph. If a match is found, the buyer's order is matched in the amount specified by the process for the buyer or specified in the seller's Sell-To list for the buyer, whichever is less. If the amount is less than the buyer's directed trade, the process executes the trade between that seller and buyer up to the limit of trading for that buyer and the process continues cycling through the remaining sellers until the entire directed buy order is fulfilled and the trade is completed. If the entire order cannot be fulfilled, the trade is aborted unless there is an optional sell order in the system or the buyer reduces its directed buy amount to the amount available through the process. As is clear from the foregoing description, multiple sellers may sell to a single buyer before the buyer's order is fulfilled (and visa versa). For every seller-buyer match, the process decrements the trade amount from the amount the buyer requested.

An aggregated borrowing limit for a buyer is set by the liquidity clearing house. Although, each seller limits the amount of its exposure from each trade with a buyer, there remains the risk that a single buyer will borrow from multiple sellers and in the aggregate take on more debt than its financial structure can handle. And consequentially be a credit risk for each of its trading partners. The aggregated borrowing limit set by the liquidity clearing house ensures that the aggregated borrowing of a given buyer is limited to avoid subjecting its seller partners to bad loans, write-downs of loans, or violation of Federal Reserve or other bank regulatory requirements. It is an additional limit on the amount an individual financial institution may borrow on a given day. The process imposed aggregated borrower limit for a single buyer is an override mechanism to decrease system wide risk from a single buyer. The liquidity clearing house sets the aggregated borrowing limit for each buyer on an individual basis, based upon a menu of factors such as the buyer's equity, the buyer's LCH Credit Score, and other criteria the liquidity clearing house, in its discretion, deems relevant to the individual buyer's risk profile.

In one embodiment of the process, the process of matching a buyer with one or more sellers comprises four or more iterations, depicted in FIG. 1 at 101-105. The four iterations are to ensure that the process addresses all directed trades with a minimum of optional trades and uses the upstream correspondent bank for clearing as many transactions as possible before using the Federal Reserve.

The first iteration 102, depicted in FIG. 1, sequences through the sellers until a seller is found that can sell to the buyer, i. e., the buyer is on the seller's Sell-To list. As previously described, the process looks at a first seller in the outer loop 107 and then sequences through the inner loop 106 of all buyers on the sellers Sell-To list. Not finding the buyer in the first seller's Sell-To list, the process cycles to the second seller in the outer loop 107 and again sequences through the inner loop 106. This step is repeated through the outer loop 107 until a match is found. The first iteration considers only directed trades (no optional trades) and excludes the Federal Reserve as a clearing bank. This iteration finds buyer-seller matches for directed trades, where the trading partners share an upstream correspondent bank as a clearing bank.

The second iteration 103 considers only trades between directed sellers and directed buyers (no optional trades) and designates the Federal Reserve as the clearing bank. This step is initiated because the directed trade initiated at 102 could not be completed. The trade could not be completed due to the lack of (a) an upstream correspondent clearing bank shared by both trading partners or (b) sellers with sufficient short term liquidity to sell to satisfy the full amount of the trade—insufficient liquidity among the selling participants. The second iteration ensures that all directed trades are completed to the limit possible even if the Federal Reserve must be utilized as the clearing bank of last resort. All trades executed by the second iteration are cleared through the Federal Reserve.

The third iteration 104 considers optional trades to meet the needs of directed trades. This iteration excludes the Federal Reserve as a clearing bank to maximize the trades going through upstream correspondent banks. The third iteration includes two passes. One attempts to match directed buy trades with optional sell trades. Another pass attempts to match directed sell trades with optional buy trades. The third iteration is designed so that an optional buy is never matched with an optional sell.

The fourth iteration 105, like the third iteration, considers optional trades and includes the Federal Reserve as a clearing bank. As previously mentioned the liquidity clearing house process is designed to maximize trading without the Federal Reserve before using it as a clearing bank of last resort.

The liquidity clearing house process depicted in FIG. 1 calculates the interest and fees at 108 for each trade executed and cleared though the system. It generates and sends a confirm to the trading buyer and seller at 109. The process also has the built in capability to capture and store information relative to each trade, as well as calculate at 110 various statistical information based upon the trades.

FIG. 2 depicts the make-up of seller initiated parameters and process initiated parameters, their updating and their approval The seller initiated parameters are set by the seller. The seller initiated parameters allows the seller to define buying partners that meet the seller's acceptable risk profile and the guidelines of Federal Reserve “Regulation F,” which limits the depository financial institution's exposure to other depository financial institutions. The process initiated parameters are set by the process. They are more restrictive than those required by Regulation F.

The seller initiated parameters, their initial entry into the process, and their periodic revision are depicted in FIG. 2, at 201-204a. A seller can set or modify its Sell-To list parameters at any time, depicted at 201. The Sell-To list parameters establish the seller's exposure limit to buyer banks. The exposure limit directives may be based upon a number of criteria, as depicted at 201a, such as: (a) a percentage of the buying institution's most recent published equity; (b) the buying institution's LCH Credit Score—better scores leads to higher amounts and visa versa; (c) a maximum amount it will sell to the buying institution; (d) including or excluding a geographic region; (e) limiting exposure more than is already limited by the liquidity clearing house's LCH Credit Score for buying institutions—as depicted in FIG. 5; (f) excluding or including financial institutions by asset size; (g) excluding or including buying financial institutions from the seller's Sell-To list for any reason; and (h) limiting the dollar amount of exposure it has with respect to a financial institution that is on the seller's Sell-To list.

A geographic region can be defined by a seller in multiple ways, which affords sellers maximum control. For example, the regions can be sections of the country (such as the northeast, southeast, Midwest, west, northwest, southwest, and the south,); states; or regions of states.

FIG. 2, at 202a, depicts the process's step of turning the seller's request to enter its Sell-To list or revisions of it into the process. Based upon the input from the seller's Sell-To list and the process's most recently stored financial data for each participating bank, the process creates a list of banks in the Sell-To list that meet the seller's parameters. It also inputs the seller's selling limit for sales to any financial institution.

In FIG. 2, at 203a, the Sell-To list created in the previous step is compiled and made available for the seller's approval, at 204a, of the input list. The Sell-To list provides information required to ensure the seller's compliance with Federal Reserve Regulation F. It includes a credit analysis report of each of the sell to banks. The report may be printed and saved by the seller.

The step of the seller's approval of the Sell-To list, at 204a, is automatically executed by the seller's authorized representative when the representative logs into the liquidity clearing house process. Upon login the representative's authorization is authenticated through a secure mechanism. Seller's authorized representative is designated by the seller. The seller may have more than one authorized representative. The individual representatives may be given authorization to access the process at different levels. For example, one representative may have authorization to modify and approve the entry of the Sell-To list. Another may have authorization to place buy or sell orders. If the person is so designated, the process will record the action taken by the representative and his/her name.

The process, at 205-204b, also has the ability to independently initiate changes to the Sell-To list. Periodically (with periodicity set as a global parameter of the liquidity clearing house process) the liquidity clearing house reviews a seller's Sell-To list to determine whether it requires revision, at 205. Revision may be required for various reasons. One reason, at 205a, is because as the number of users of the liquidity clearing house process grows, additional banks are added as buyers and sellers in the process. However, even if a seller has indicated that all buyers in a certain region of the country are approved, the liquidity clearing house can not add a buyer to a seller's Sell-To list without the seller's explicit approval. Revisions are also made by the process when it receives updated institutional financials, at 205a. This may give rise to the addition or deletion of buyers. If at any time a buyer is removed from the list of eligible buyers by the liquidity clearing house due to changes in financials, changes in LCH Credit Score, or for any other reason, all participant sellers are prohibited by the process from selling to the removed buyer even if the buyer is approved by the seller.

During the process's periodic, transparent cycle through the liquidity clearing house list of participants, it will revise each seller's Sell-To list to reflect any changes entered into the process by a seller, depicted in step 201. If the new list contains additional financial institutions, then a pending Sell-To list will be created at 202b. The pending list includes only the added institutions. The process will remind a user at logon that pending changes to its Sell-To list require user's approval or disapproval.

As depicted in FIG. 2 at 203b, when the user indicates it wishes to approve the pending Sell-To list, the process provides the user access to the pending Sell-To list. The pending Sell-To list only includes the pending changes, it does not include information that is not subject to change. If the user wants to access its entire Sell-To list, it can request it at 201-204a.

FIG. 2 at 204b signifies the financial institution's approval of the pending Sell-To list. The process will authenticate the institution's log-in at 204b by reading a secured look up table stored in the process. The look up table contains the authorizations for each institution's personnel and the level of authorization, including the user's authority to approve the pending Sell-To list. The institution's administrator will have previously entered the authorizations into the process. A process journal entry, will record the date of approval, name of approving user, and an indication of what was approved.

FIG. 3 graphically depicts the credit risk mitigators used by the liquidity clearing house to reduce the seller's trading risk. The seller's risk is mitigated by selling only to those buyers the seller specifies as those to whom it will sell 301. The Sell-To list is the seller's list of such banks. The seller's Sell-To list is loaded onto, and stored in, the system. As described in FIG. 2, the liquidity clearing house allows users to create, review, and approve the list of buyers to which they will sell. The clearing house will ensure that every time the seller enters a sell trading amount, the sale will be only to those buyers on seller's Sell-To list.

The seller may also limit its dollar exposure to any approved buyer 302. The seller may set its dollar exposure limit as a function of: (a) a percent of the buyer's equity; (b) a percent of the seller's equity; (c) a function of the LCH Credit Score; (d) a specific number set by the seller; and (e) any combination of the foregoing.

Seller's risk is further reduced by limiting the aggregate sales of all of the sellers to any one buyer 303. Although, each seller determines its exposure to one buyer, the liquidity clearing house sets its own criteria for the amount any buyer can purchase. The process limits may be a function of: (a) the buyer's equity; (b) the LCH Credit Score; (c) a fixed preset number; and (d) any combination of the foregoing.

Randomization is added to the liquidity clearing house to diversify the buyers to whom a seller will sell 304. On a daily basis, both the list of sellers and the Sell-To lists are randomized. Randomization greatly reduces the probability that a seller will sell to the same buyer on consecutive days. Randomization diversifies exposure, spreads risk evenly, and reduces risk for each individual seller.

On a regular basis the clearing house inputs into system memory updated financials of all sellers and buyers and initiates recalculation of the LCH Credit Scores of each seller and buyer 305. The regularity will depend on the availability of data. The FDIC offers Call Report data on a quarterly basis. So quarterly may be the default refresh time, but this will change if any source becomes more frequently available. The liquidity clearing house will not rely on buyers to provide financials. The process will obtain data from third party regulators or other trusted sources. With updated financials, the clearing house recalculates and readjusts exposure limits. The process expresses the exposure limits in the form of the LCH Credit Score. The Sell-To lists will be reviewed to determine if any limits set by the seller become more restrictive. If a seller specifies a limit based upon a percent of equity or an LCH Credit Score, these too will be recalculated. If the new limits are more restrictive, the more restrictive limits will be entered into the process immediately and limit trading activity accordingly. If any of the foregoing are less restrictive, the changes will be placed in a pending Sell-To list file accessible by the seller. The new less restrictive limit will be incorporated into the process upon the seller's input of its approval. In other words, the liquidity clearing house process will never automatically increase any seller limits, but it will automatically decrease seller limits as needed.

The liquidity clearing house also reviews its own buyer limits 306, which are a function of LCH Credit Score and equity limits. An outcome of the process's review of its buyer's limits may be that a buyer is placed in the “extended program” or removed from buying entirely. The extended program is an unsecured Federal Funds borrowing program that requires the buyer to pay a rate above the standard buy interest rate, which is referred to as the extended buy rate. A buyer may be placed in the extended program because: (a) its LCH Credit Score is in the extended program range (FIG. 5 at 504); (b) its historical buying behavior is such that the buyer does not qualify for the “regular program” (FIG. 3 at 306); or (c) the liquidity clearing house process decides to place the buyer in the extended program for whatever reason the administrator feels is appropriate. A seller selling to a buyer in the extended program receives the full extended spread on top of the directed spread to compensate the seller for its added risk. The buyer pays the higher interest rate on its borrowings because it has a higher risk profile.

The clearing house also monitors buying behavior and adjusts seller exposure based on that behavior, as depicted at 306. The example, which follows, illustrates this.
If, during every rolling 90 day period, a buyer purchases funds more than 25 days during the rolling period but less than 35 days during the rolling period, the process places the buyer in the extended program. As a result the buyer must purchase funds at a higher interest rate. The higher rate is the extended buy rate. The extended buy rate is the sum of the directed buy rate and the difference between the extended buy rate and the directed buy rate. And the difference between the extended buy rate and the directed buy rate is the extended spread. In one embodiment, extended spread interest is passed on directly to the seller to reward the seller with a higher rate of return for its higher risk. And the process does not share in the extended spread. Sellers may specify whether they wish to do extended spread selling and if not, the process will never execute a sale by the opted out seller to extended program buyers. If the buyer has purchased funds for more than 35 days, the buyer is removed from buying all together. The rolling period, the minimum number of days a buyer has purchased funds, and the maximum number of days a buyer has purchased funds may differ from those used in this example. Nevertheless, the concept is that the process uses a set of parameters to reduce risk to sellers and increase their return for higher risk selling.

Sales of funds by sellers will be diversified across multiple buyers. As the sellers restrict buyers with the tools described in this specification, their exposure to any single buyer will be reduced. Therefore, it will not be uncommon that the process will direct seller trades to multiple buyers, possibly a high number of buyers.

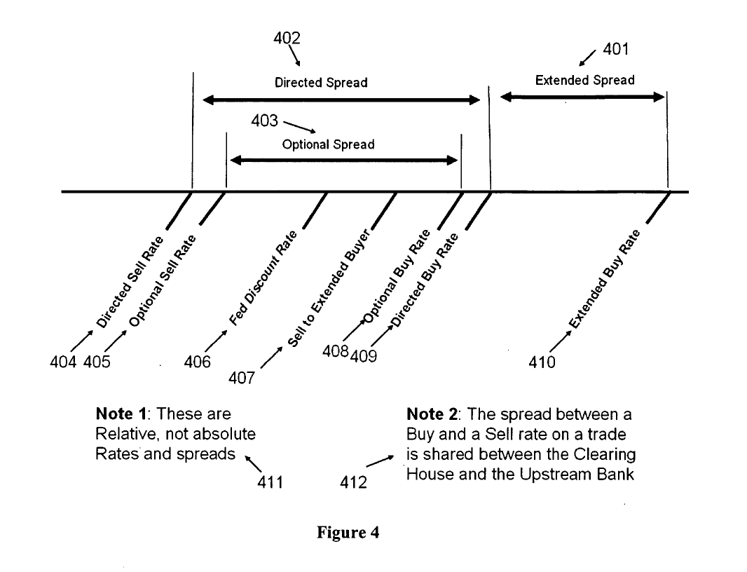

FIG. 4 depicts relative rates and rate spreads of the clearing house process, as noted in FIG. 4 at 1. It does not depict fixed spreads. Neither does FIG. 4 depict absolute differences. The rates do not represent actual numbers or in any way reflect absolute levels set by the clearing house.

Directed trades are trades for participants who enter their trade for a specified currency amount.

Directed sell rate 404 is the interest rate earned by a directed trade seller for its sale of funds into the directed program.

Directed buy rate is the interest rate earned by a directed trade buyer for its purchase of funds through the directed program.

Directed spread 402 is the spread or difference between the directed buy rate 409 and the directed sell rate 404.

Optional trades are trades for participants who enter their trade for an unspecified amount.

Optional sell rate 405 is the rate earned by an optional trade seller for its sale of funds into the optional program. The sale of funds into the optional program is allowed only if there is unmet directed trade buying. The optional sell rate is slightly enhanced from the directed sell rate to compensate the seller for the uncertain trade amount.

Optional buy rate 408 is the rate earned by an optional trade buyer for its purchase of funds in the optional program. The purchase of funds in the optional program is allowed only if there is unmet directed trade selling. The optional buy rate 408 is slightly enhanced from the directed buy rate 409 to compensate the buyer for the uncertain trade amount.

Optional spread 403 is the spread or difference between optional buy rate 408 and optional sell rate 405. Optional spread 403 is smaller than directed spread 402, since optional trade buyers and sellers receive a slightly better rate on either side. The clearing house will never allow a trade between an optional trade buyer and an optional trade seller. Optional trade buyers will buy from directed trade sellers and optional trade sellers will sell to directed trade buyers. Optional trades are only available to accommodate unmet directed trades.

Extended trades are trades for participants that are placed by the process in the extended program.

Extended sell rate 407 is the rate earned by a seller for sale of its funds to an extended buyer. For a directed sell, the extended sell rate 407 is the sum of the directed sell rate 404 and the directed spread 402. Directed sell rate 404 is enhanced from extended sell rate 407 to compensate the seller for the added risk of selling to an extended buyer.

Extended buy rate 410 is the rate paid by buyers in the extended program. For a directed buy, the extended buy rate is the sum of the directed buy rate 409 and the extended spread 401. The buyer pays the higher rate because the buyer has been automatically placed in the extended program by the clearing house. The buyer has been placed in the extended program for reasons that could include the buyer's LCH Credit Score or because the buyer has been buying for a number of days that places it in the extended program.

Extended spread 401 is the amount the directed buy rate is increased when the buyer is in the extended program.

The Fed Discount rate 406 is the rate set by the Federal Reserve FOMC (Federal Open Market Committee) as a target rate for Federal Funds. It is included in FIG. 4 as a point of reference.

The interest spread between buying and selling on any trade is shared between the liquidity clearing house and the upstream correspondent bank with a larger share going to the upstream correspondent bank, as noted in FIG. 4 at 2. The dollars shared are based on net interest income realized from the trade. It is calculated as the product of (a) the difference between the buy rate and the sell rate divided by 360 and (b) the number of days of the trade. The number of days of the trade is the difference between the maturity date and the issue date of the trade. The number of days of the trade for Fed Funds trades is usually one to two days for week days and three days for weekends.

FIG. 5 depicts aspects of the LCH Credit Score. The LCH Credit Score is a credit risk measure. It is used by the clearing house to mitigate the selling participant's credit risk. The LCH Credit Score is determined by the process for each buyer participant. The parameters included in the LCH Credit Score and its application to each selling participant is fully disclosed to all buying and selling participants. The LCH Credit Score is based upon commonly used financial institution analytics that reflect the financial institutions ability to its honor credit obligations. The Score comprises a combination of financial ratios and values obtained from third party sources such as Call Report data published by the FDIC. The LCH Credit Score is determined by the process and is not subject to change by the individual financial institutions. The determination is subject to revision by the liquidity clearing house. The clearing house may place a buyer in a different risk category or remove it from trading for any reason based upon an updated LCH Credit Score that is more restrictive than the buyer's previous LCH Credit Score. The LCH Credit Score is not only used to place potential buyers into different risk categories. In some cases, it is used to prevent a buyer from participating in buying funds at all. Revision of the LCH Credit Score is generally made to reflect changing dynamics of (a) the financial institution's balance sheet and income statement, (b) regulatory concerns, and (c) the economy. The LCH Credit Score is not the only mechanism used to determine whether a financial institution may participate in the clearing house. The liquidity clearing house may apply any additional criterion it deems fit.

FIG. 5 depicts the LCH Credit Score components used by the process to limit seller's risk. The LCH Credit Score, in effect, overrides seller inputted credit risk factors if the process calculated LCH Credit Score for a buyer indicates that the buyer is a high risk credit even though, based upon the seller's criteria, a seller would allow a sale to the buyer.

On a quarterly basis at a minimum, and possibly more frequently depending upon data availability, the process will make available on-line to all financial institution participants the updated financials of all participants 501. The FDIC is a source of this data, as well as other trusted sources. After the financial data is updated on the system 502, the process will determine the LCH Credit Score for each participant. The LCH Credit Score determination will be available for review on-line by all participants. The determination is a function of the components shown at 502. The components may include capital adequacy, asset quality, earnings coverage, liquidity, and other components. The LCH Credit Score is based upon a weighting of the components listed at 502. The LCH Credit Scores are normalized, as depicted at 504, across a zero to one hundred scoring range. Scores under 50 may be considered at risk and the liquidity clearing house will not allow any unsecured borrowing by such a participant. The parameters for the at risk buyer may be changed by the process. However, an LCH Credit Score, below which a buyer is deemed at risk, may influence a financial institution buyer to not become a participant in the process. It is generally agreed that traders of Fed Funds and other short term liquidity want controlled risk. It is believed that the components shown at 502 are the components that would satisfy a financial institution and garner its support as a participant. However, traders in different markets may be less risk averse, or possibly even more risk averse, and therefore the process risk parameters may be changed by the process accordingly for those markets. The LCH Credit Score at 504 illustrates an example of the categorization of participant buyers into the regular program, extended program, and secured program. As previously mentioned, those buyers with LCH Credit Scores under 50 will not be allowed to purchase Federal Funds in the unsecured market. They will be able to buy funds on a reverse repo basis. Those with LCH Credit Scores between 50 and 70 will only be allowed to buy in the extended program. They must pay the extended buy rate for their trades. Those participants with LCH Credit Scores above 70 may buy in the regular Fed Funds program.

FIGS. 8A and B are an example of the LCH Credit Score for a hypothetical representative financial institution.

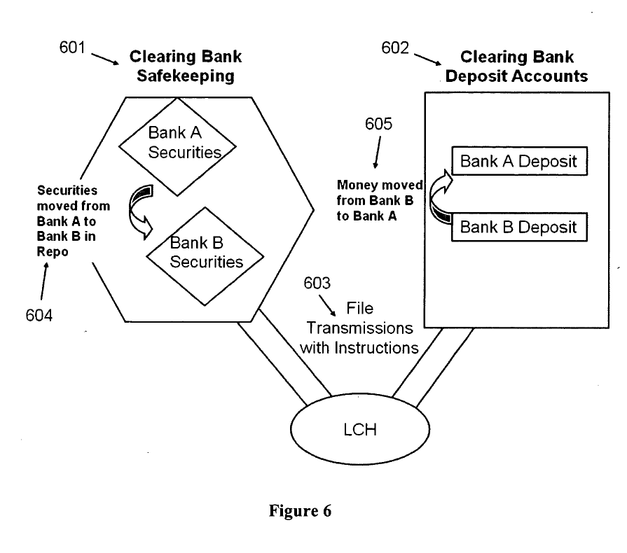

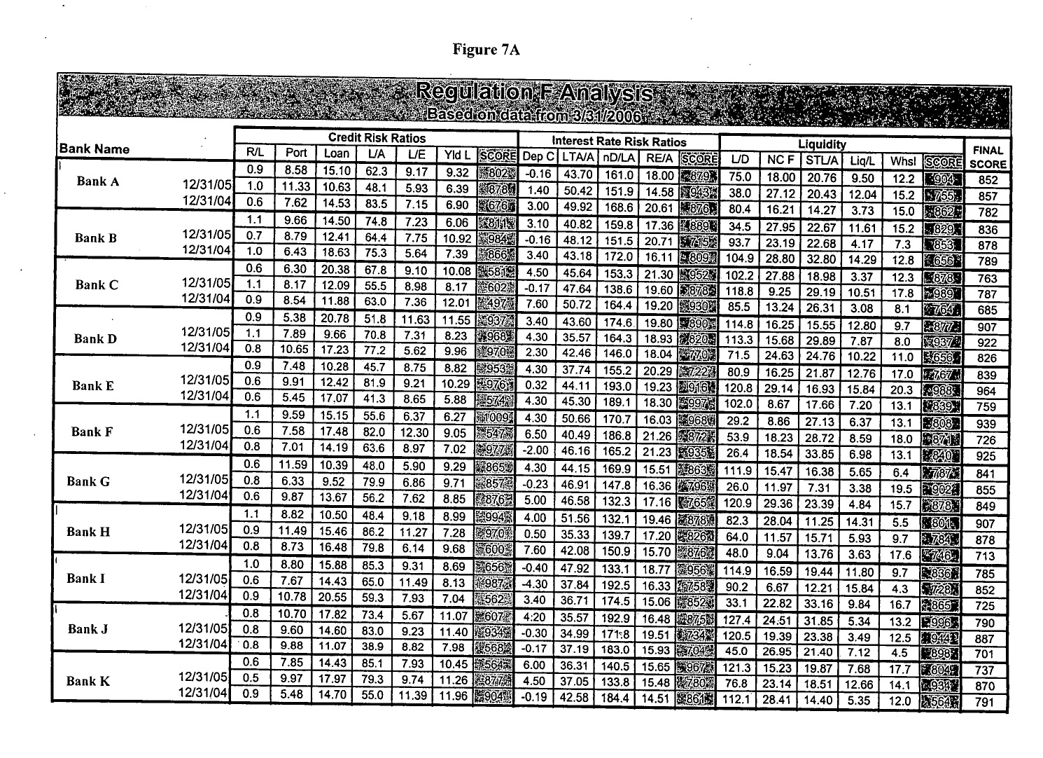

FIG. 6 depicts aspects of the secured program. The liquidity clearing house secured program automatically trades liquid funds between participants, notwithstanding that the trade must be secured by the buyer's securities. Some participants, usually sellers, may wish to trade on a secured basis. Others, usually buyers, may have no choice because the participant is excluded from the regular and extended programs. The secured program (sometimes referred to as the repo program) has requirements in addition to those in the regular and extended programs, both of which are unsecured. The secured program buyer and seller must have a safekeeping arrangement with one of the liquidity clearing house upstream correspondent banks. They must also enter into a repurchase arrangement among the upstream correspondent bank, buyer (downstream correspondent bank), and the liquidity clearing house. The safekeeping arrangement is a common service offered by upstream correspondent banks to downstream correspondent banks.

The upstream correspondent bank (Bank A at 604) holds and maintains some or all of a buying participant's investment portfolio. The clearing house in this embodiment requires the participant's security to be bonds, but in other embodiments the security may be another form of investment grade security.

The upstream correspondent bank perfects the seller's interest in the buyer's securities by transferring the buyer's securities (held by Bank A at 604 for safekeeping) to the upstream correspondent bank (held by Bank B at 604 for safekeeping).

The upstream correspondent bank is both the clearing bank for the safekeeping accounts, in which the securities are held, depicted at 601, and for the deposit accounts, in which the liquid funds are held, depicted at 602. The clearing house requires that the upstream correspondent bank be capable of perfecting the seller's interest in the buyer's securities, which are subject to the terms of a repurchase agreement. A secured trading transaction is initiated by the process by directing the clearing bank 601 in its safekeeping mode to transfer the buyer's securities (in Bank A at 604 for safekeeping) to the seller's safekeeping account (in Bank B at 604) to secure the buying participant's promise to repay the seller's short term loan of Fed Funds. The process completes the trading transaction by directing the transfer of the seller's Fed Funds or other liquid finds deposited at seller's Bank B 605 to the buyer for deposit at buyer's Bank A 605.

When the clearing house is trading securities and a repo trade has been created between a buyer and a seller, both of who have safekeeping accounts and deposit accounts at the same upstream correspondent bank, the liquidity clearing house sends two file transmissions with instructions 603 to the upstream correspondent bank. An example illustrates the foregoing.
Bank B (the seller of Fed Funds)is buying a repurchase agreement from Bank A (the buyer of Fed Funds), and thus Bank A (the buyer) will be transferring investment securities to Bank B (the seller). The first of the two file transmissions 603 will go to the upstream correspondent bank's deposit account and create the transaction to debit Bank B (the seller) and credit Bank A (the buyer) with the amount of the transaction. The second of the two file transmissions 603 will go to the upstream correspondent bank's safekeeping system and transfer (perfect interest in) the securities of Bank A (the buyer) to Bank B (the seller). At maturity (typically the next business day unless this is a term transaction) the two transactions will be automatically reversed.

The transfer of securities from Bank A (the buyer), to Bank B (the seller) is depicted at 604. The amount of the securities will be an amount such that the market value (not the book value) of the securities will be at least sufficient to cover the amount of liquid funds moved from Bank B (the seller) to Bank A (the buyer). This transaction will be automatically reversed at maturity of the repurchase agreement. The transfer of dollars by the clearing bank from Bank B (the seller) to Bank A (the buyer) at 605 represents the purchase of the funds by the buyer from the seller, which is recorded as a debit trade currency amount to the seller's deposit account and a credit trade currency amount to the buyer's deposit account.

Examples of hypothetical reports generated by the clearing house process are presented in FIGS. 7-12. FIG. 7 is a Regulation F analysis. An LCH Bank Score report is shown in FIGS. 8A and B. FIG. 9 is a daily Federal Funds confirmation report. FIG. 10 is a daily confirmation report. FIG. 11 is an exposure report. FIGS. 12A and B are monthly summary reports.

The liquidity clearing house process may run on an internet accessible group of dual processor Microsoft Windows based servers, held in a secure hosting site which satisfies the security protection, redundancy, backup, and recovery dimensions commonly found in a well designed financial data system holding private information.

The most efficient usage of the embodiments of the clearing house process is implemented on a computer with various combinations of hardware and software, which one of ordinary skill in the art of computer technology would readily be aware. Such a computer-implemented apparatus may provide all or some of the means for performing the steps and functions of the embodiments described in this specification.

Those of ordinary skill in the art of trading will appreciate that changes can be made to the embodiments described in this specification without departing from the concept of the embodiments. The clearing house process described is not limited to the particular embodiments disclosed. If it is limited, it is limited only by the claims.

We claim:

1. A computer process for automating management of subscriber short term liquidity, comprising the steps of: (a) calculating a risk parameter for seller subscribers based upon published buyer subscriber (i) financial information and (ii) short term liquidity borrowing activity; (b) specifying buyer subscribers to which a seller subscriber will sell short term liquidity and listing the maximum amount the seller subscriber will sell to each specified buyer subscriber; (c) disclosing rates for buying short term liquidity and selling short term liquidity in advance of trading short term liquidity; (d) providing directed short term liquidity trading, optionally, in (i) a target amount over a specific period of time or (ii) a specific amount at a specific time; (e) providing optional short term liquidity trading to satisfy unmet directed short term liquidity trading; (f) trading short term liquidity buyer subscriber and seller subscriber orders by matching a buying subscriber with a selling subscriber that (i) meets the selling subscriber's risk parameter and (ii) has the same clearing house as the selling subscriber; (g) satisfying directed trades and then satisfying unmet directed trades with optional trades; (h) executing final settlement of trades through the buying and selling subscribers' respective settlement accounts; and (i) sending confirmation of trades to selling and buying subscribers.

2. The computer process of claim 1, wherein calculating the risk parameter is based upon parameters comprising: (a) Tier 1 capital; (b) ratio of equity to total assets; (c) ratio of nonperforming loans to total assets; (d) percentage change in ratio of nonperforming loans to total assets; (e) ratio of nonperforming loans to total equity; (f) percentage change in ratio of equity to total assets; (g) loan to deposit ratio; (h) net interest margin, comprised of the ratio of net interest income over earning assets; (i) absolute change in net interest margin; and (j) other factors chosen by the process from time to time.

3. The computer process of claim 2, wherein the parameters upon which risk is calculated also comprise buyer subscriber credit worthiness based upon buyer subscriber's (a) adequacy of capital; (b) asset quality; (c) earnings coverage; and (d) liquidity.

4. The computer process of claim 3, wherein calculation of the risk parameter comprises periodically determining an LCH Score by translating the combined risk parameters into a number between zero and one-hundred.

5. The computer process of claim 1, wherein specifying buyer subscribers to which a seller subscriber will sell short term liquidity comprises using parameters to specify buyer subscribers, the parameters comprising (a) a buyer subscriber's LCH Credit Score, Federal Reserve Call Report Data, and geographic region of the country and (b) the seller subscriber's exclusion of specific buyer subscribers and inclusion of specific buyer subscribers.

6. The computer process of claim 1, comprising management of seller subscriber, credit risk by the following: (a) if a buyer subscriber buys short term liquidity more than X days in a rolling Z day period and less than Y days in a rolling-Z day period, buyer subscriber pays seller subscriber an extended interest rate spread, where X, Y, and Z are set as a system parameter; (b) if a buyer subscriber buys short term liquidity more than Y days in a rolling Z day period, the buyer subscriber may not buy short term liquidity at all and must use secured buying of short term liquidity, where Y and Z are set as a system parameter; and (c) managing buyer subscriber buying in any other manner.

7. The computer process of claim 1, wherein the disclosed rates are guaranteed.

8. The computer process of claim 1, wherein the target amount comprises an amount the subscriber designates to be maintained in its upstream correspondent account over a specific period of time.

9. The computer process of claim 8, wherein the directed trade amount to maintain the target amount comprises the difference between (a) the amount the subscriber designates to be maintained in its account over the specific period of time and (b) an amount that is the actual balance in the subscriber's account at the time of the trade.

10. The computer process of claim 1, further comprising a four iteration algorithm for matching buyers with sellers.

11. The computer process of claim 10, comprising: (a) the first iteration matching seller subscriber directed trades with buyer subscriber directed trades if buyer subscriber fits seller subscriber's risk parameters and buyer and seller subscribers share a common clearing bank that is not the Federal Reserve Bank; (b) the second iteration matching remaining unmatched seller subscriber directed trades with buyer subscriber directed trades if buyer subscriber fits seller subscriber's' risk parameters and buyer and seller subscribers share a common clearing bank, including the Federal Reserve Bank; (c) the third iteration matching any remaining unmatched seller subscriber directed trades with buyer subscriber optional trades if buyer subscriber fits seller subscriber's risk parameters and buyer and seller subscribers share a common clearing bank that is not the Federal Reserve Bank; (d) the third iteration matching any remaining seller subscriber optional trades with buyer subscriber directed trades if buyer subscriber fits seller subscriber's risk parameters and buyer and seller subscribers share a common clearing bank that is not the Federal Reserve Bank; (e) the fourth iteration matching seller subscriber (i) directed trades with buyer subscriber optional trades if buyer subscriber fits seller subscriber's risk parameters and buyer and seller subscribers share a common clearing bank, including the Federal Reserve Bank and (ii) optional trades with buyer subscriber directed trades if buyer subscriber fits seller subscriber risk parameters and buyer and seller subscribers share a common clearing bank, including the Federal Reserve Bank.

12. A computer process for trading short term liquidity, comprising: (a) calculating a risk parameter for seller subscribers; (b) specifying buyer subscribers to which a seller subscriber will sell short term liquidity; (c) disclosing rates for buying short term liquidity in advance of trading short term liquidity; and (d) trading short term liquidity by matching a buying subscriber with a selling subscriber that meets the selling subscriber's risk parameter.

13. The computer process of claim 12, wherein the risk parameter comprises a risk parameter established by a seller subscriber.

14. The computer process of claim 12, wherein the risk parameter comprises a risk parameter established by the computer process.

15. The computer process of claim 12, wherein the risk parameter comprises a risk parameter established by a seller subscriber and a risk parameter established by the computer process.

16. The computer process of claim 15, wherein the risk parameter established by the selling subscriber is saved in memory as a sell-to list.

17. The computer process of claim 16, wherein the sell-to list comprises risk parameters based on buying subscribers' (a) geographic area; (b) LCH Score; (c) asset size; (d) maximum or minimum trade amount; (e) percent of equity; (f) other criterion; and (g) all of the foregoing.

18. The computer process of claim 13, comprising the computer process proposing modifications to the sell-to list and modification of the sell-to list upon approval of the seller subscriber.

19. The computer process of claim 18, wherein the modifications comprise (a) addition or deletion of subscribers; (b) update of subscriber financial information; and (c) all of the foregoing.

20. The computer process of claim 15, wherein the risk parameter established by the computer process comprises: (a) restricting trades to buyer subscribers meeting the sell-to list risk parameters; (b) restricting trades to buyer subscribers meeting an aggregated borrowing limit; (c) periodically randomizing the order of buyer subscribers on the sell-to-list; (d) periodically updating buyer subscriber financial information; (e) increasing the interest rate for buyer subscriber trades exceeding a periodic trading frequency; (f) establishing an LCH Score for each buyer subscriber; (g) spreading buyer subscriber trade amounts among multiple seller subscribers; and (h) spreading seller subscriber trade amounts among multiple buyer subscribers.

21. The computer process of claim 12, wherein the calculated risk parameter is an LCH Score.

22. The computer process of claim 21, wherein the LCH Score represents a buyer subscriber's credit worthiness.

23. The computer process of claim 22, wherein a buyer subscriber's credit worthiness comprises evaluation of the buyer subscriber's (a) capital amount, (b) asset quality, (c) earnings coverage, (d) liquidity, and (e) all of the foregoing.

24. The computer process of claim 23, wherein a buyer subscriber's capital amount is comprised of the buyer subscriber's (a) amount of equity, (b) amount of assets, and (c) all of the foregoing.

25. The computer process of claim 23, wherein a buyer subscriber's asset quality is comprised of the buyer subscriber's (a) ratio of nonperforming loans to asset amount, (b) percent of change in ratio of nonperforming loans to asset amount, (c) ratio of nonperforming loans to equity amount, (d) percent of change in ratio of nonperforming loans to equity amount, and (e) all of the foregoing.

26. The computer process of claim 23, wherein a buyer subscriber's earnings coverage is comprised of the buyer subscriber's (a) ratio of equity to assets, (b) ratio of equity to return on assets, (c) ratio of equity to overhead, (d) ratio of equity to net earnings on assets, (e) percent of change in the foregoing ratios, and (f) all of the foregoing.

27. The computer process of claim 23, wherein a buyer subscriber's liquidity is comprised of the buyer subscriber's (a) loan to deposit ratio, (b) percent change in loan to deposit ratio, and (c) all of the foregoing.

28. The computer process of claim 20, comprising categorizing a buyer subscriber into risk classes based upon the buyer subscriber's LCH Score.

29. The computer process of claim 28, comprising classes of buyer subscriber's that are authorized to trade (a) unsecured without a rate enhancement, (b) unsecured with a rate enhancement, and (c) secured.

30. The computer process of claim 12, wherein matching a buy order with a sell order comprises cycling through a nested loop.

31. The computer process of claim 30, wherein the step of cycling through a nested loop comprises cycling through an outer loop and inner loop.

32. The computer process of claim 31, wherein cycling through the inner loop comprises (a) determining whether the buyer subscriber is on a seller subscriber's sell-to list, (b) if so, determining whether the buyer subscriber and seller subscriber have a common clearing house, and (c) if so, executing the trade between the buyer subscriber and seller subscriber.

33. The computer process of claim 32, also comprising limiting the trade to the lesser of (a) seller's selling limit for the buyer, (b) buyer's requested trade amount, and (c) aggregated buying limit for the buyer.

34. The computer process of claim 31, wherein cycling through the outer loop comprises (a) repeating clause—a—of claim 32 until it is determined that the buyer is on a subsequent sell-to list, (b) if buyer is on a subsequent sell-to list, executing clause—b—of claim 32, (c) if buyer subscriber and seller subscriber have a common clearing house, executing clause—c—of claim 32, and (d) if buyer is not on a sell-to list or buyer and seller do not have a common clearing house, cease repeating step—a—of claim 22.

35. The computer process of claim 33, also comprising (a) determining whether the buyer's requested trade amount was satisfied in full, (b) if not, determining whether the buyer is on a subsequent seller's Sell-To list, (b) if so, executing step—b—of claim 32, (c) if so, executing step—c—of claim 32 for the unsatisfied amount.

36. The computer process of claim 35, comprising (a) determining whether the buyer's requested trade amount was unable to be satisfied in full and (b) if not, aborting the transaction unless there is an optional sell order in the computer process.

37. The computer process of claim 32, wherein the matching of buyers and sellers comprises four iterations in which the: (a) first iteration considers only directed trades and excludes the Federal Reserve as the clearing bank; (b) second iteration considers only trades between directed sellers and directed buyers and designates the Federal Reserve as the clearing bank; (c) third iteration considers optional trades to meet the needs of directed trades and excludes the Federal Reserve as the clearing bank; and (d) fourth iteration considers optional trades to meet the needs of directed trades and includes the Federal Reserve as the clearing bank.

38. The computer process of claim 12, comprising: (a) calculating interest on seller loans to buyer; (b) calculating fees on trading transactions; (c) generating confirms; (d) making confirms available to buyer and seller; (e) capturing individual trade information; and (f) capturing aggregated trading activity statistical information.

39. The computer process of claim 12, comprising a buyer's pledge of assets to a seller to secure seller's loan of short term liquid funds to buyer.

40. The computer process of claim 39, comprising buyer and seller safekeeping accounts and deposit accounts at the same upstream correspondent bank.

41. The computer process of claim 40, comprising (a) transferring the pledged assets from buyer safekeeping account to seller safekeeping account and (b) debiting seller deposit account in the amount of seller loan and crediting buyer deposit account in the amount seller loan.

42. The computer process of claim 41, comprising reversing the transactions in steps—a—and—b—of claim 31 at maturity.

43. The computer process of claim 17, wherein the sell-to list also comprises specifically named buyers.

44. The computer process of claim 9, wherein the directed trade amount to maintain the target amount comprises a directed sale of funds if the difference between the account balance and the target balance is positive and a directed buy of funds if the difference between the account balance and the target balance is negative.

45. The computer process of claim 44, wherein the subscriber's account is maintained with an upstream.

46. The computer process of claim 8, wherein the specific period of time is a specific period of days.

47. The computer process of claim 1, wherein the specific time is a specific day.
